(19) United States
(12) Patent Application Publication
(10) Pub. No.: US 2006/0246205 A1
(43) Pub. Date: Nov. 2, 2006

(54) Dehydrated instant potato product and low carbohydrate dehydrated instant potato product

(76) Inventor: L. Anslem Goonetilleke, Plymouth, MN (US)

Correspondence Address: GENERAL MILLS, INC., P.O. BOX 1113, MINNEAPOLIS, MN, 55440, US

(21) Appl. No.: 11/119,875

(22) Filed: May 2, 2005

(51) Int. Cl. A23L 1/216

(52) U.S. Cl. 426/637

(57) ABSTRACT

The invention provides both regular and low-carbohydrate versions of a dehydrated instant potato product comprising from about 2% to about 25% of at least one texturizing agent. Inclusion of the texturizing agent provides a mashed potato product having improved texture and increased consumer acceptance when compared to other types of dehydrated instant potato products.

### THE FIELD OF THE INVENTION

The present invention relates generally to a dehydrated potato product. More specifically, the invention relates to a dehydrated instant potato product having an improved texture and to a low-carbohydrate version of a dehydrated instant potato product having good texture and creaminess.

### BACKGROUND OF THE INVENTION

Dehydrated instant potato products have been known for many years. Such products have been available in forms such as potato flakes, potato granules and potato agglomerates. Such products provide convenience for the preparation of mashed potatoes in the home without the need for time consuming steps of peeling, dicing, cooking and mashing. The products are available in different versions, e.g., with different flavorings such as butter or garlic and more recently in versions meeting specific dietary needs, such as low-fat and low carbohydrate versions.

U.S. Pat. No. 4,241,094 discloses a process for the production of dehydrated instant potato product which, when prepared, have a taste and texture similar to freshly prepared mashed potato products.

U.S. Pat. No. 4,084,008 discloses an instantized dehydrated instant potato product and a process for producing the product wherein the potatoes are washed, peeled and cut into pieces, which are then blanched, treated in a sulfite solution and then partially dehydrated to a moisture content of between 35-65%, and then steamed cooked and dehydrated to a moisture content of less than about 10%.

U.S. Pat. No. 4,110,478 discloses dehydrated potato granules prepared by cooking, mashing, freezing, thawing, predrying to a moisture content of between 35-45%, granulating and then finally drying to a moisture content no greater than about 7%.

U.S. Pat. No. 4,241,094 discloses a process for the production of dehydrated potatoes which are more similar to freshly prepared mashed potatoes. Two groups of potatoes are cooking with one group being cooked, riced, peeled and cooled while the other group is peeled, sliced, blanched, cooled, cooked, riced and then cooled. The combined groups are then flaked. The combination of two groups with different cooking methods is taught to provide a more desirable texture.

U.S. Pat. No. 4,770,892 discloses a potato flake or granule with an added portion of potato granules as an additive wherein that additive portion is prepared from potato pieces which are partially cooked, dried and reduced to a 0.25-2.5 mm particle size. These pieces provide the appearance of small pieces of fresh potato in the reconstituted product, which are believed to make the product more similar to freshly “home-made” mashed potatoes.

U.S. Pat. No. 6,777,020 B2 discloses a potato flake product and production method as well as a dough formulation made in part from the potato flakes which can be used for other potato products such as potato based snack foods, especially fabricated chips.

Recently regimens and foodstuffs low in carbohydrate content have been popularized for those dieting and for those with health conditions related to sugar intake. Potatoes contain significant quantities of complex carbohydrates and have traditionally been excluded from such diets. However, potatoes are very desirable foods to most of the population, and are greatly missed when excluded totally from the diet. It is therefore desirable to have a dehydrated instant potato product which contains less potato content and is therefore acceptable to persons on a low-carbohydrate regimen. However, previous attempts to develop such a product have focused on the substitution of cauliflower for at least a portion of the potatoes in dehydrated instant potato products, and have proved an unsatisfactory substitute in both taste and texture.

U.S. Published Patent Application 2003/108,654 discloses low-carbohydrate potato products which include potato and cauliflower mixed together with a suitable binder. The non-carbohydrate binder/filler components disclosed include protein concentrates, protein salts, powdered celluloses, calcium caseinate and the like.

For this reason, it would be desirable to have a low-carbohydrate potato product developed without the use of cauliflower and that would have a taste and texture similar to regular potato products when cooked.

### SUMMARY OF THE INVENTION

The invention provides a dehydrated instant potato product including at least one texturizing agent.

The invention further provides a dehydrated instant potato product comprising from about 2% to about 25% of at least one texturizing agent.

Mashed potatoes made using products of the invention have improved consumer acceptance when compared to mashed potatoes made from a similar product which does not include a texturizing agent.

In one embodiment, the dehydrated instant potato product of the invention is a regular dehydrated instant potato product comprising a texturizing agent.

In another embodiment, the dehydrated instant potato product is a low-carbohydrate dehydrated instant potato product comprising at least one texturizing agent.

One embodiment of the invention provides a dehydrated instant potato product comprising from about 10% to about 20% of at least one texturizing agent.

In another embodiment of the dehydrated instant potato product, the texturizing agent is a leavening agent.

In another embodiment, the texturizing agent may be selected from the group consisting of sodium bicarbonate, cream of tartar, and mixtures thereof.

In another embodiment, a dehydrated instant potato product comprises from about 5% to about 10% of sodium bicarbonate and from about 5% to about 10% cream of tartar.

As used herein, these terms have the following meanings.

1. The term “texturizing agent” means a leavening agent which imparts improved texture to the dehydrated instant potato product.

2. The term “mashed potatoes” includes potato products made by mixing a dehydrated instant potato product with water.

3. The term “dehydrated instant potato product” includes, but is not limited to, potato flakes, potato granules, potato agglomerates, and mixtures thereof.

4. The term “emulsifier” refers to a chemical substance that keeps fats (or oils) dispersed in water or water droplets dispersed in fats (or oils). Emulsifiers are used in foods containing both fats/oils and water.

5. The term “cream of tartar” is known in food science and refers to potassium bitartarate.

6. The term “leavening agent” refers to an agent or system that causes carbon dioxide to be formed within a food product which in turn exhibits an increase in volume, commonly called “rising”.

7. The term “soy bean isolate” refers to a product made from defatted soy beans which contain about 90% protein and very little carbohydrate.

8. The term “low carbohydrate” means a product which has a reduced amount of carbohydrate per serving when compared to a standard product.

### DETAILED DESCRIPTION OF THE INVENTION

Products of the invention are dehydrated instant potato products; such products may be provided in the form of granules or flakes, buds, slices, dices or shreds, or other known forms of such products.

The primary component of a dehydrated instant potato product is potato. Potatoes for such products are processed prior to cooking by washing to remove adhering soil, peeling, and forming into pieces by slicing or dicing or grating. The peeling may be done by means of steam and lye peeling or by abrasion or any other known process. The potatoes may also be treated chemically, for example with citric acid, ascorbic acid and the like before cooking to prevent darkening of the potato pieces. The potato pieces are then cooked, typically in a steam bath or by boiling. The cooking may involve a first blanching step and a second cooking step, or merely one combined cooking step. The potato pieces are then mashed and dehydrated and formed into their final shapes by various processes known in the art. If flakes are desired, a flaking operation such as that disclosed in U.S. Pat. No. 3,535,128 may be used. If potato granules are preferred, a granulating operation such as that disclosed in U.S. Pat. No. 4,100,478 may be used. Additives and flavorings such as fats, milk products, seasonings, and butter notes are added, and the potatoes are cooled to ambient temperatures. The final dehydrated instant potato product typically has a stable moisture content of less than 10%, preferably less than about 7%. These steps are merely exemplary, and any conventional processing steps may be used as desired. For example, the potato pieces may be partially dehydrated prior to cooking or the drying and dehydration may be conducted after the potatoes are cooked.

The invention provides a “regular” dehydrated instant potato product and a low-carbohydrate version, both of which have an improved texture due to the use of a texturizing agent.

Both types of dehydrated instant potato product of the invention include at least one texturizing agent. Useful texturizing agents are chemical leavening agents, which can be either food grade acids or bases, or a combination thereof. Leavening agents are agents, or systems comprising multiple agents, that cause carbon dioxide to be formed within a food product which in turn exhibits an increase in volume. Useful leavening agents include both acids and bases. Some examples of useful leavening acids include sodium or calcium salts of ortho, pyro, and complex phosphoric acids in which at least two active hydrogen ions are attached to the molecule. Baking acids include monocalcium phosphate monohydrate (MCP), monocalcium phosphate anhydrous (AMCP), sodium acid pyrophosphate (SAPP), sodium aluminum phosphate (SALP), dicalcium phosphate dihydrate (DPD), dicalcium phosphate (DCP), sodium aluminum sulfate (SAS), glucono-delta-lactone (GDL), potassium hydrogen tartrate (cream of tartar) and the like. A leavening system can include a heat activated leavening acid such as sodium acid pyrophosphate and a leavening base (e.g., sodium bicarbonate).

Sodium bicarbonate, or baking soda, as it is known in the food industry, is a leavening base that is stable and relatively inexpensive to produce. Baking soda can be used in either an encapsulated form or in a non-encapsulated form. Use of an encapsulated baking soda delays the onset of the leavening reaction as the encapsulating material must first be dissolved before the leavening reaction can occur. When baking soda is used as the texturizing agent in dehydrated instant potato products of the invention, it is typically present in an amount of from about 2% to about 20%. When baking soda is used as one texturizing agent and at least one other texturizing agent is present, the baking soda is typically present in an amount of from about 2% to about 10%, preferably from about 5% to about 10%.

Cream of tartar is another common leavening agent, which may be used in dehydrated instant potato products of the invention. Cream of tartar is a natural, pure ingredient left behind after grape juice has fermented to wine, and is commonly used as one of the major ingredients in baking powder. Cream of tartar, as noted above, is the common name for potassium hydrogen tartarate, and is the salt of an acid leavening agent. When cream of tartar is used as the texturizing agent in dehydrated instant potato products of the invention, it is typically present in an amount of from about 2% to about 20%. When cream of tartar is used as one texturizing agent and at least one other texturizing agent is present, it is typically present in an amount of from about 2% to about 10%, preferably from about 5% to about 10%.

The dehydrated instant potato products of the invention may include one or more emulsifiers as processing aids. Emulsifiers reduce stickiness of the mash and provide lubrication which may reduce cell damage during processing. When used, the emulsifier(s) typically comprise from about 0.01% to about 5%, more typically from about 0.01% to about 2%. Useful emulsifiers include lecithin, glycerides, monoglycerides and diglycerides of partially hydrogenated oils such as soybean oil, sorbitan esters, lactate esters, and the like.

Dehydrated instant potato products of the invention, both regular and low-carbohydrate versions, typically include a fat or oil, with such terms being used interchangeably to include natural or synthetic fats and oils such as soybean oil, corn oil, cottonseed oil, sunflower oil, palm oil, coconut oil, canola oil, lard, tallow, and the like.

Both regular and low carbohydrate versions of the product may include other carbohydrates as well. Such products include, but are not limited to, dextrins such as maltodextrins and fructo-oligosaccharide molecules (FOS) such as inulin. Additional carbohydrates and starches may be added to further improve the texture of the product; such added carbohydrates may be derived from any source including grains such as corn, wheat, rice, barley, tapioca, sago and mixtures of such grains. Hydrolyzed starches such as casein are also useful. Dextrins are easily digestible carbohydrates made from grains. Fructo-oligosaccharide molecules are natural storage carbohydrates found in numerous edible plant species including chicory, artichoke, leek, onion, asparagus, wheat, barley, rye, garlic, and bananas. Inulin and related FOS are good sources of soluble fiber and may boost calcium absorption. Inulin may also help promote a healthy digestive system by stimulating the growth of beneficial bifidobacteria in the lower intestine. Inulin has only 1.5 calories per gram, compared to 4 calories per gram for other carbohydrates and 9 calories per gram for fats, and so is useful in the low carbohydrate products as well as the regular version of the product.

Dehydrated instant potato products of the invention may also include a milk source, which may be added as a fresh product or in dried or powdered form, and may include any type of milk such as cream, milk, buttermilk and the like.

Dehydrated instant potato products of the invention also include flavorings and seasonings which may be included directly in the product or may be provided in a separate seasoning mixture or both. Useful flavorings include, but are not limited to, methoxy pyrazines, garlic, butter and margarine notes, pepper, salt, and herbs such as rosemary, thyme, parsley and the like.

Dehydrated instant potato products of the invention may also be fortified with vitamins and minerals such as riboflavin, niacin and vitamin B₆.

In a reduced carbohydrate dehydrated instant potato product, some portion of the potato is replaced with other food content having a lower net carbohydrate content than potatoes. This presents additional challenges in that such materials typically change the flavor and texture of the dehydrated instant potato product and of the mashed potatoes made therefrom. Many manufacturers have added dehydrated cauliflower; however, this addition causes both taste and texture problems.

Low-carbohydrate dehydrated instant potato products of the invention include a lower amount of potato and include one or more non-carbohydrate or low-carbohydrate filler materials. Useful filler materials include grain fibers such as oat fiber or rice solids and protein concentrates. Such filler materials may be present in the low-carbohydrate product in an amount up to about 50% of the product formulation. Useful protein concentrates include soy protein isolates, soy protein concentrates, and the like. In one embodiment, the low-carbohydrate dehydrated instant potato product of the invention contains a soy protein isolate. Soy bean isolates are made from defatted soy beans which have also had most of the carbohydrates removed so that they contain about 90% protein and thus have less carbohydrate and less soy bean taste than other soy products. When a soy bean isolate is used in a low-carbohydrate dehydrated instant potato product of the invention, it is typically present in an amount of up to about 30%, preferably up to about 25% of the filler (non-potato) portion of the product, or up to about 15% of the total product formulation.

In one embodiment, a low-carbohydrate dehydrated instant potato product of the invention comprises about 50% dehydrated potato, and about 50% non-potato filler and seasonings, such non-potato portion including from about 20% to about 25% protein isolates and up to about 30% oat fiber.

Other optional ingredients which can be added to both versions of the dehydrated instant potato products include thickeners such as carrageenan, stabilizers such as sodium alginate or sulfites, including sodium sulfite, sodium bisulfite and the like, and, preservatives such as citric acid, monosodium glutamate, BHA and BHT. Food safe colorings and flow agents may also be added.

Mashed potatoes made from dehydrated instant potato products of the invention have an improved texture and have a “mouthfeel” more like fresh potatoes to the eater when compared to a similar instant potato product without a texturizing agent. Such sensory characterizations may include specific factors which can be tested such as stiffness or firmness, stickiness, slipperiness, surface wetness, cohesiveness, moistness, adhesiveness to the palate and the like. The sensory characteristics can be tested via American Society for Testing and Materials International (ASTM International, 100 Barr Harbor Drive, West Conshohocken, Pa. 19428-2959) methodologies, specifically “Sensory Testing Methods,” Manual 26, 2^{nd} ed., Sponsored by Committee 18 on Sensory Evaluation of Materials and Products, 1996. Consumer sensory characterizations also include personal expectations for a product based on past potato products consumed, ideation related to the perfect taste and texture of a potato product, scent, flavor, and the like, which are not easily quantified. Mashed potatoes made from dehydrated instant potato products of the invention also have an improved appearance to the consumer, being “fluffier” than similar products without the texturizing agent, and not appearing pasty.

### EXAMPLE 1

The potato flakes were processed from round, mature tubers and conformed to regulations set forth in the Federal Food, Drug and Cosmetic Act. Potatoes were destoned and thoroughly washed to remove dirt, foreign substances and sorted to remove all undesirable tubers. After washing, the potatoes were graded according to numerous factors. The potatoes were then peeled by steam and sliced to a uniform thickness to facilitate fast and uniform cooking. The sliced potatoes were blanched at 200° F. to inactivate undesirable enzymatic activity, e.g., peroxidase and catalase activity. After the blanching step, the blanched potatoes were cooled. The blanched potatoes were then subjected to steam cooking at conditions of atmospheric steam. The cooked potatoes were riced and additives were added to the potatoes. Additives included shelf life extenders and processing aids. Additives used were for the prevention of non-enzymatic browning, oxidative rancidity and pastiness and as processing aids such as the following additives: sodium bisulfite, sodium acid pyrophosphate, butylated hydroxyl anisole and/or BHT, citric acid and emulsifiers such as mono and diglycerides and others. The potatoes were then subjected to a flaking operation where the mashed potatoes were dried to a moisture content of 5 to 7.5% in less than 20 seconds. The potato flakes, or “buds” were then ready for packaging.

A seasoning mix was made containing butter notes, and various flavorings desired for the particular version of the potato product; many combinations are possible such as cheese flavorings, sour cream and chive, or garlic flavors. The flavors were mixed with fillers such as proteins and soy isolates or whey protein isolates, and emulsifiers such as mono and diglycerides. Each ingredient was weighed and the seasoning mix was then placed into a separate pouch (the seasoning mix can also be placed into the same pouch as the potato buds, if desired). The texturizing agent or agents were also weighed and placed into the pouch containing the seasoning mixture.

More specifically, this seasoning mixture contained from about 10% to about 13% Inulin, from about 12 to about 23 percent of a spice mixture comprising salt, pepper, butter flavor, MSG and garlic, from about 2% to about 4% of sodium bicarbonate as a texturizing agent, 9-15% vegetable oil, from about 2% to about 4% of sodium bicarbonate as a texturizing agent, 25-35% oat fiber, from about 23% to about 30% protein isolates, from about 2% to about 10% maltodextrins, from about 2% to about 5% gum, and from about 0.1 to about 0.3% silicon dioxide.

The packaging of the individual pouches employed equipment from KHS-Bartelt, Inc., of Sarasota, Fla. The machine formed pouches from plastic sheeting by first forming the sheet into individual “V” or “W” shaped channels, depending on the capacity needed, and then heat sealing at the left and right of the pouches. The pouches are then separated and each pouch is filled with the desired ingredients, and then heat sealed across the top of the pouch to form a fully sealed pouch. However, any known packaging methods and equipment useful for packaging food items may be employed to make similar products of the invention. After the pouch(es) are sealed, they are further packaged into a final pouch or box.

A mashed potato dish is created from this product by mixing the potato buds, seasoning mix, and milk or water or a mixture thereof and adding margarine or butter, if desired.

What is claimed is:

1. A dehydrated instant potato product comprising from about 2% to about 25% of at least one texturizing agent.

2. A dehydrated instant potato product according to claim 1 comprising from about 10% to about 20% of said at least one texturizing agent.

3. A dehydrated instant potato product according to claim 1 wherein said texturizing agent is selected from the group consisting of sodium bicarbonate, cream of tartar, and mixtures thereof.

4. A dehydrated instant potato product according to claim 3 comprising from about 5% to about 10% of sodium bicarbonate and from about 5% to about 10% cream of tartar.

5. A dehydrated instant potato product according to claim 1 wherein said product is in the form of a granule.

6. A dehydrated instant potato product according to claim 1 wherein said product is in the form of a flake.

7. A dehydrated instant potato product according to claim 1 wherein said product comprises up to about 90% potato.

8. A dehydrated instant potato product according to claim 1 wherein said product further includes non-potato carbohydrate sources.

9. A dehydrated instant potato product according to claim 1 wherein said product further includes at least one source of fat.

10. A dehydrated instant potato product according to claim 9 wherein said product includes at least one fat source selected from the group consisting of vegetable oils, oil and at least one fat source selected from the group consisting of butter and margarine.

11. A dehydrated instant potato product according to claim 1 wherein said product further includes natural and artificial flavors.

12. A dehydrated instant potato product according to claim 11 wherein said product is provided in first and second separate pouches, wherein said first pouch contains said potato granules and said second pouch contains natural and artificial flavors.

13. A dehydrated instant potato product according to claim 1 wherein said product is a low carbohydrate potato product comprising up to about 50% of at least one non-potato filler selected from the group consisting of oat flour and soy protein isolates.

14. A dehydrated instant potato product according to claim 13 wherein said product comprises up to about 50% potato.

15. A dehydrated instant potato product according to claim 13 wherein said potato product contains no more than about 20 grams total carbohydrate per serving.

16. A dehydrated instant potato product according to claim 13 wherein said product contains no more than about 20 grams of net carbohydrate per serving.

17. A dehydrated instant potato product according to claim 16 wherein said product contains no more than about 15 grams of net carbohydrate per serving.
